(19) United States
(12) Patent Application Publication
(10) Pub. No.: US 2023/0127433 A1
(43) Pub. Date: Apr. 27, 2023

(54) FASTENING DEVICE FOR A SENSOR

(71) Applicant: VEGA GRIESHABER KG, Wolfach (DE)

(72) Inventors: Florian KRAEMER, Muehlenbach (DE); Patrick HEIZMANN, Oberwolfach (DE); Stefan ALLGAIER, Oberwolfach (DE)

(73) Assignee: VEGA GRIESHABER KG, Wolfach (DE)

(21) Appl. No.: 17/996,162

(22) PCT Filed: Apr. 15, 2020
(86) PCT No.: PCT/EP2020/060614

§ 371 Date: Oct. 13, 2022

(51) Int. Cl. G01F 23/284; H01Q 1/22

(52) U.S. Cl. CPC G01F 23/284; H01Q 1/225

(57) ABSTRACT

A mounting device is provided for a sensor, configured to attach the sensor to a container, including: a first mechanical interface configured to attach the mounting device to a corresponding first mating mechanical interface of the container; and a second mechanical interface configured to attach the mounting device to a corresponding second mating mechanical interface of the container, in which the mounting device is configured to receive the sensor. A container having a mounting device, and a method of attaching a sensor to a container, are also provided.

### FIELD OF INVENTION

The invention relates to the attachment of sensors in an industrial environment. In particular, the invention relates to a mounting device for a sensor configured to attach the sensor to a container, a container having a mounting device attached thereto, a use of such a mounting device, and a method of attaching a sensor to a container.

### BACKGROUND

Sensors in the industrial environment can be configured for level measurement, level limit detection, flow measurement, pressure measurement, level and flow velocity measurement, and temperature measurement. Such sensors can be configured for attachment on or in an opening of a vessel. They are mounted either by means of a flange fastening or a screw-in fastening.

In the case of flange mounting, the sensor, for example a level measuring device or a point level sensor, has a plate-shaped flange which surrounds the antenna neck of the device in a flange-like manner in order to be screwed to a corresponding mating flange in the area of the opening of the container.

In the case of screw-in mounting, the antenna neck itself is equipped with an external thread so that the sensor can be screwed into a corresponding internal thread in a container opening via the external thread.

In addition, it is possible to attach sensors to the vessel by means of mounting clamps, bayonet catches or clamp brackets.

### SUMMARY

It is an object of the invention to provide an alternative means of attaching sensors to a container.

This object is solved by the subject matter of the independent patent claims. Further embodiments of the invention result from the subclaims and the following description of embodiments.

A first aspect of the present disclosure relates to a sensor mounting device configured to mount the sensor to or within a container. The mounting device (attachment device, fastening device) comprises a first mechanical interface configured to attach the mounting device to a corresponding first mating mechanical interface of the container. It further comprises a second mechanical interface configured to attach the mounting device to a corresponding second mating mechanical interface of the container. The mounting device is configured to receive the sensor. The receiving device of the sensor can be configured in such a way that the sensor can also be removed again from the mounting device. However, the sensor can also be permanently integrated in the mounting device, movable or immovable.

The terms “first mechanical interface” and “second mechanical interface” or “mechanical interface” in general are to be interpreted broadly. In particular, the fastening device may have more than two mechanical interfaces. The mechanical interfaces are suitable and arranged for releasable or non-releasable attachment of the fastening device (and thus also of the sensor) to a container wall or a container opening. Examples of mechanical interfaces include internal or external threads, flange mounts, ceiling mounts, pipe mounts, or clamps. Provision may be made for an adapter flange to be screwed onto the existing thread and thus used. Other mounting options, such as a pipe clamp, can also be mounted on the threads as an add-on.

The mounting device can be in the form of a housing into which the sensor can be inserted or integrated. The mechanical interfaces are thus arranged around the sensor, for example. The sensor can thus be located in the center of the fastening device. The mechanical interfaces of the fastening device may be designed to be replaceable or may be permanently attached to the base body of the fastening device. For example, the fastening device is designed as a single piece. However, it may also be provided that the individual mechanical interfaces are screwed into the fastening device.

For example, the base body of the fastening device is cube- or cuboid-shaped, with, for example, round recesses in two or more of the side surfaces, which have a mechanical mating interface, such as an internal thread, into which corresponding mechanical interfaces can be screwed.

The sensor can be configured for process automation in an industrial environment. The term “process automation in the industrial environment” can be understood as a subfield of technology that includes all measures for the operation of machines and plants without the involvement of humans. One goal of process automation is to automate the interaction of individual components of a plant, for example in the chemical, food, pharmaceutical, petroleum, paper, cement, shipping or mining industries. A wide range of sensors can be used for this purpose, which are adapted in particular to the specific requirements of the process industry, such as mechanical stability, insensitivity to contamination, extreme temperatures and extreme pressures. Measured values from these sensors are usually transmitted to a control room, where process parameters such as level, limit level, flow rate, pressure or density can be monitored and settings for the entire plant can be changed manually or automatically.

One subarea of process automation in the industrial environment concerns logistics automation. With the help of distance and angle sensors, processes within a building or within an individual logistics facility are automated in the field of logistics automation. Typical applications include systems for logistics automation in the area of baggage and freight handling at airports, in the area of traffic monitoring (toll systems), in retail, parcel distribution or also in the area of building security (access control). Common to the examples listed above is that presence detection in combination with precise measurement of the size and location of an object is required by the respective application side. Sensors based on optical measurement methods using lasers, LEDs, 2D cameras or 3D cameras that measure distances according to the time-of-flight (ToF) principle can be used for this purpose.

Another sub-area of process automation in the industrial environment concerns factory/production automation. Use cases for this can be found in a wide variety of industries such as automotive manufacturing, food production, the pharmaceutical industry or generally in the field of packaging. The goal of factory automation is to automate the production of goods by machines, production lines and/or robots, i.e. to let it run without the involvement of humans. The sensors used in this process and the specific requirements with regard to measuring accuracy when detecting the position and size of an object are comparable to those in the previous example of logistics automation.

According to an embodiment, the mechanical interfaces are different interfaces. For example, the first mechanical interface has an external thread with a first diameter and the second mechanical interface has an external thread with a second, different diameter. However, it may also be the case that the first mechanical interface is a flanged attachment and the second mechanical interface is a clamp attachment, or an adhesive surface, configured to adhere the attachment device to the wall of the container.

According to another embodiment, the first mechanical interface and the second mechanical interface are located in opposite regions of the mounting device. For example, the actual sensor is located between these two areas and can measure through the first mechanical interface and/or the second mechanical interface.

According to a further embodiment, the mounting device is made of metal or a plastic. In the latter case, it is permeable to radar measurement signals, so that a penetration described below may not be necessary, since the sensor can measure through the fastening device.

In particular, in the latter case, provision can be made for the sensor to be integrated on the mounting device during its manufacture, e.g. to be overmolded.

According to another embodiment, the mounting device is manufactured using an injection molding process.

According to a further embodiment, the first mechanical interface has a first thread and/or the second mechanical interface has a second thread. The thread diameters can be different or identical. The latter in particular if the fastening device is to provide an attachment to the inside or outside of the container or a container opening or a side wall of the container and the top of the container. The threads are, for example, threads of types G, NPT, NPTF and/or R.

According to a further embodiment, the mounting device is configured for optional fastening to a side wall of the container or to the ceiling of the container, the orientation of the mounting device being identical for fastening to the side wall and for fastening to the ceiling. In this case, the two mechanical interfaces are not located opposite each other, but have an angle of 90 degrees to each other.

According to a further embodiment, the mounting device has two, three, four or more further mechanical interfaces.

The interfaces can be designed to be interchangeable, e.g. by means of a bayonet catch or screw-in thread. For example, the basic body (the “cube”) has six bayonet catches so that the appropriate interface can be mounted in the desired installation position in each case.

For example, all mechanical interfaces are arranged in pairs opposite each other, like the sides of a cube.

According to another embodiment, the mounting device comprises a base body that is arranged to hold the sensor and to which the mechanical interfaces are attached.

According to one embodiment, the mounting device allows the sensor to be installed in all four or six layers.

Provision may be made for one or more of the mechanical interfaces to be replaceable by being bolted to or otherwise releasably attached to the base body.

According to another embodiment, the base body has a cube-like shape.

According to a further embodiment, the base body has a through-hole or recess or hole through which the measurement signal of the sensor can be emitted.

According to a further embodiment, the base body has a spherical or otherwise shaped bearing that is set up to movably support the sensor arranged in the base body.

According to a further embodiment, the base body (or the sensor mounting) has a locking element, set up to fix the sensor in the mounting.

The sensor and mounting can be configured so that the sensor aligns itself via gravity so that it always radiates vertically downwards, regardless of the orientation of the mounting device.

According to a further embodiment, the base body or the bearing has an alignment element, set up for aligning the sensor. The alignment of the sensor can be performed manually or automatically.

According to another embodiment, the mounting device has a sensor disposed therein.

According to a further embodiment, the sensor is a level measuring device, for example a level radar device, a limit level sensor, a pressure sensor or a flow sensor.

Another aspect of the present disclosure relates to the use of a mounting device described above and below for mounting a sensor selectively on a side wall of a container or the ceiling of the container. In either case, after the sensor has been mounted and oriented, the sensor points downwardly toward the medium to be measured or in another “measurement direction”.

Another aspect of the present disclosure relates to a container having a mounting device attached thereto as described above and below.

Another aspect of the further disclosure relates to a method for attaching a sensor to a container, wherein first the sensor is attached to or in a mounting device and thereafter the mounting device is optionally attached to a first mechanical mating interface of the container or to a second mechanical mating interface of the container. According to a further embodiment, an alignment of the sensor in the measuring direction takes place after or during the fastening, whereby the measuring direction can be identical for both fastening positions (from the side wall or at the ceiling).

Further embodiments are described below with reference to the figures. The illustrations in the figures are schematic and not to scale. If the same reference signs are used in the following description of the figures, these designate the same or similar elements.

### BRIEF DESCRIPTION OF THE FIGURES

FIG. 1 shows a mounting device with a sensor mounted therein according to an embodiment.

FIG. 2 shows a fastening device according to a further embodiment.

FIG. 3 shows a fastening device according to a further embodiment.

FIG. 4 shows a container with two fastening devices attached thereto according to an embodiment.

FIG. 5 shows a flow diagram of a process according to an embodiment.

FIG. 6 shows a fastening device that has a cube shape.

### DETAILED DESCRIPTION OF EMBODIMENTS

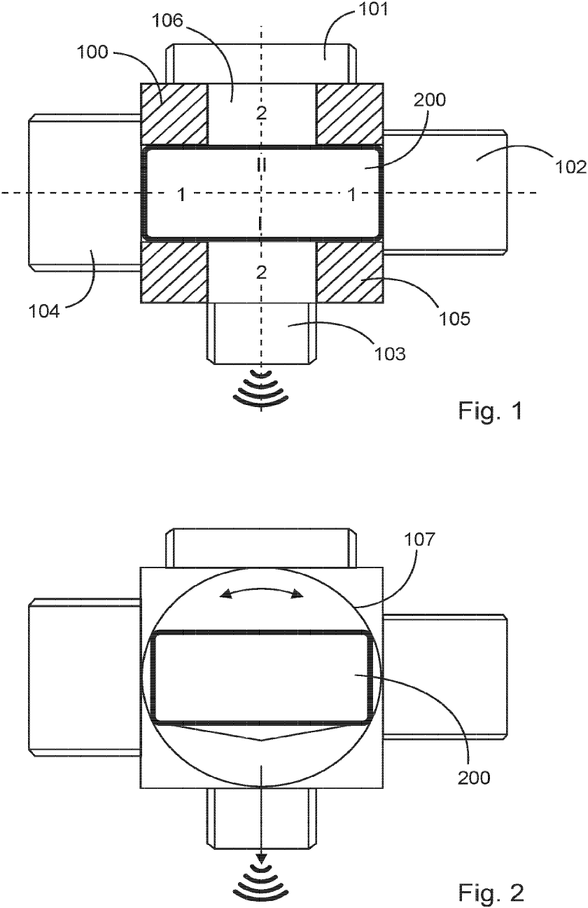

FIG. 1 shows a sensor 200 installed in a mounting device 100. The sensor 200 can be screwed into the side of the fastening device or inserted therein and clamped therein, for example.

The mounting device 100 has four or more mechanical interfaces 101, 102, 103, 104, each of which is disposed on a side of the cube-shaped base body 105 of the fastening device 100. The base body and mechanical interfaces may be made in one piece. However, it may also be provided that one or more of the mechanical interfaces are detachably attached to the base body.

A plurality of passages 106 are provided through which the sensor 200 can measure. This “universal mounting” for sensors, which provides various mounting options for attachment to a container or other device, can significantly reduce the amount of assembly required, particularly for interchangeable level and limit sensors. The sensors 200 no longer need to be individually manufactured with an appropriate suitable process connection, as the mounting device 100 provides several different process connections for mounting the sensor.

An integrated seal can ensure that the measuring point is still sealed against the process. For example, each mechanical interface has its own seal.

The mounting device may be arranged in the manner of a sensor housing so that it protects the sensor 200 from mechanical damage. The mounting device 100 may have mechanical interfaces in the form of internal or external threads, flanges, ceiling brackets, pipe brackets or clamps (so-called clamp connections).

For example, the mounting device may be configured to allow the sensor 200 to be inserted in the four different orientations or positions (vertical/horizontal and sensor orientation top/bottom, respectively).

The mechanical interfaces 104, 102 may be used to attach the fastening device to a side wall or an opening in a side wall of the container, or to a ceiling. The mechanical interfaces 101, 103 are used to attach the fastening device internally or externally to a ceiling or ceiling opening of the container. With all four mechanical interfaces, the mounting device can be mounted laterally or from above. The sensor can then always be mounted in the appropriate orientation using the horizontal and vertical inserts.

FIG. 2 shows a mounting device 100 in which the sensor 200 is slidably mounted in the bearing 107, which may be in the form of a round piece. It may be envisaged that the sensor 200 aligns itself via gravity. In the case of FIG. 2, the sensor 200 is a radar sensor with an antenna which radiates the measuring signal (see arrow) vertically downwards in the direction of the product surface.

The sensor can therefore align itself independently, automatically towards the measuring point.

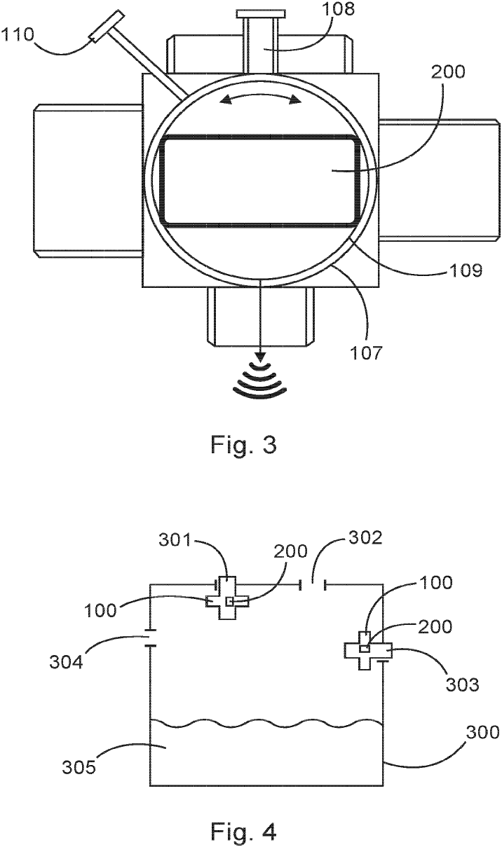

FIG. 3 shows another embodiment that also allows sensor alignment. Here, the sensor 200 is fixed in the round piece 109. The round piece 109 is rotatably mounted in the spherical bearing 107. The sensor 200 can be aligned manually. For this purpose, a lever 110 is provided for alignment, which can be operated from the outside. Furthermore, a locking element 108 in the form of a set screw or as a spring-loaded locking element in the form of a pin is provided to lock the aligned sensor. The term locking element is to be interpreted broadly. Likewise, the term alignment element.

The sensor 200 can be encapsulated and has, for example, a completely closed plastic housing that cannot be opened non-destructively and only has wireless interfaces to the outside. In particular, the sensor can be a self-sufficient sensor with its own power supply. Self-sufficient sensors can be designed to be medium-tight and pressure-resistant. Thus, the measuring point could be flooded.

Sealing can be ensured by using a sealing system, e.g. O-ring or flange seal, at the process connection. The thread of the respective mechanical interface can also be designed to be self-sealing.

The mounting device can be used advantageously for self-sufficient sensors that are to be used temporarily at different measuring points/mounting options.

An adapter system may also be provided on which various process connections can be mounted, for example in the form of a bayonet fitting on the mounting device on which various threaded connections can be mounted.

Or different adapter flanges are provided, which can be mounted on the threaded connections that are on the mounting device. It is also possible that on the adapter system the threads / process connections are designed interchangeably to provide an even greater variance.

The adapter system can be attached via an external or internal thread.

FIG. 4 shows a container 300 in which a filling material 305 is located. The side walls of the container have openings in the form of mechanical mating interfaces 303, 304, as does the top of the container (see interfaces 301, 302).

A first attachment device 100 is disposed at the mating mechanical interface 303, and a second attachment device 100 is disposed at the mating mechanical interface 301. A sensor is disposed in each. The fastening device can be mounted on the inside or also on the outside of the container.

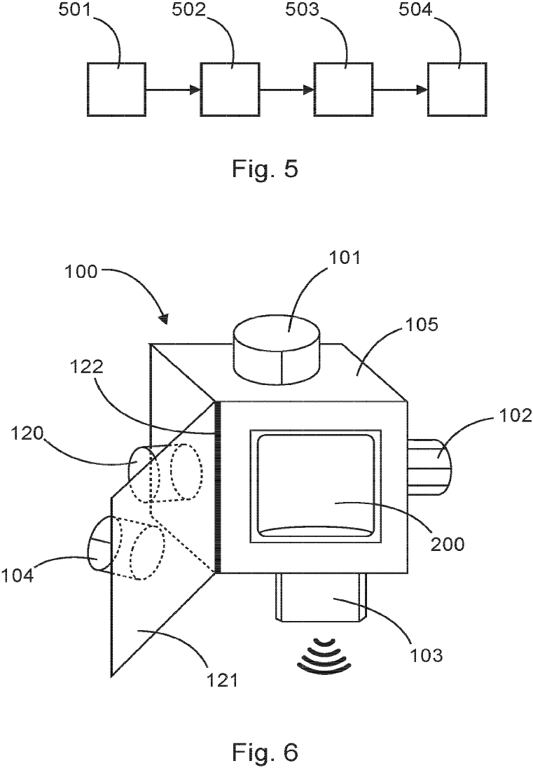

FIG. 5 shows a flow diagram of a method according to an embodiment. In step 501, a sensor is attached to or in a mounting device. In step 502, the attachment device is attached to a first mating mechanical interface of the container. In step 503, it is removed from this interface and attached to a second mechanical mating interface of the container. In both steps 502, 504, the sensor can be oriented accordingly so that it measures in the same direction in each case, although the housing is in different orientations.

FIG. 6 shows a mounting device 100 which has a cube shape and can have up to six mechanical interfaces 101,102, 103, 104, 120 by means of a door 121 which can be pivoted by means of a scraper 122. Due to the cubic structure of the mounting space, which is located inside the mounting device, it is sufficient that the sensor receptacle has only one mounting position of the sensor 200.

Supplementally, it should be noted that “comprising” and “having” do not exclude other elements or steps, and the indefinite articles “a” or “an” do not exclude a plurality. It should further be noted that features or steps that have been described with reference to any of the above embodiments may also be used in combination with other features or steps of other embodiments described above. Reference signs in the claims are not to be regarded as limitations.

1-19. (canceled)

20. A mounting device for a sensor, configured to attach the sensor to a container, comprising:
a first mechanical interface configured to attach the mounting device to a corresponding first mating mechanical interface of the container; and
a second mechanical interface configured to attach the mounting device to a corresponding second mating mechanical interface of the container,
wherein the mounting device is configured to receive the sensor.

21. The mounting device according to claim 20,
wherein the first mechanical interface and the second mechanical interface are different mechanical interfaces.

22. The mounting device according to claim 20,
wherein the first mechanical interface and the second mechanical interface are arranged in opposite regions of the mounting device.

23. The mounting device according to claim 20,
wherein the first mechanical interface comprises a first thread, and/or
wherein the second mechanical interface comprises a second thread.

24. The mounting device according to claim 20,
wherein the mounting device is further configured for selective attachment to a side wall of the container or to a ceiling of the container, and
wherein an orientation of the mounting device is identical when attaching to the side wall and when attaching to the ceiling.

25. The mounting device according to claim 20,
wherein the mounting device includes two, three, four, or more further mechanical interfaces.

26. The mounting device according to claim 25,
wherein the mechanical interfaces are arranged in opposing pairs.

27. The mounting device according to claim 20, further comprising a base body configured to hold the sensor and to which the first and the second mechanical interfaces are attached.

28. The mounting device according to claim 27,
wherein the base body has a cube-like shape.

29. The mounting device according to claim 27,
wherein the base body has a through-hole through which a measurement signal of the sensor is emitted.

30. The mounting device according to claim 27,
wherein the base body comprises a spherical bearing, configured to movably support the sensor.

31. The mounting device according to claim 30,
wherein the base body comprises a locking element, configured for fixing the sensor in the bearing.

32. The mounting device according to claim 27,
wherein the base body comprises an alignment element, configured to align the sensor.

33. The mounting device according to claim 20, further comprising the sensor disposed therein.

34. The mounting device according to claim 20, wherein the sensor is a level meter, a point level sensor, a pressure sensor, or a flow sensor.

35. The mounting device according to claim 20, wherein the mounting device is further configured to selectively attach the sensor to a side wall of the container or to a ceiling of the container.

36. A container having a mounting device according to claim 20.

37. A method of attaching a sensor to a container, comprising the steps of:
mounting the sensor to or in a mounting device; and
selectively attaching the mounting device to a first mating mechanical interface of the container or to a second mating mechanical interface of the container.

38. The method according to claim 37, further comprising the step of aligning the sensor.
